(19) United States
(12) Patent Application Publication
(10) Pub. No.: US 2008/0049716 A1
(43) Pub. Date: Feb. 28, 2008

(54) Error rate based power management of a high-speed serial link

(75) Inventors: Peter R. Munguia, Chandler, AZ (US); Gabriel R. Munguia, Phoenix, AZ (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/480,007

(22) Filed: Jun. 30, 2006

(51) Int. Cl. H04L 12/28

(52) U.S. Cl. 370/351

(57) ABSTRACT

A method, circuit, and system are disclosed. In one embodiment, the method comprises dynamically adjusting the output voltage of the output drivers of one side of a bi-directional serial link down to the lowest voltage level that is able to maintain compliance with the error rate allowance threshold of the serial link, and operating the one side of the serial link at that voltage level.

### FIELD OF THE INVENTION

The invention relates to power management of a high-speed serial link.

### BACKGROUND OF THE INVENTION

The use of high-speed bi-directional serial links is becoming prevalent in computer systems today. PCI-Express™ and Serial Advanced Technology Attachment (SATA) links are two of the many popular serial links. In all of these serial links, voltage is fixed at a value to support the minimum and maximum specification requirements without regard to a variable load or noise application of the port.

Power management is very important in all computer systems today as well. Power savings is important for any system, but mobile systems are especially targeted for as much power reduction as possible to lengthen the life of the computer's battery. Currently for serial links, power is only managed by throttling traffic across the link or idling the port.

### DESCRIPTION OF THE DRAWINGS

The present invention is illustrated by way of example and is not limited by the figures of the accompanying drawings, in which like references indicate similar elements, and in which:

FIG. 1 is a block diagram of a computer system which may be used with embodiments of the present invention.

FIG. 2 describes one embodiment of an Error Rate Power Management Controller coupled to the transmission and receiving lines of one end of a high-speed bi-directional serial link.

FIG. 3 is a flow diagram of one embodiment of a process to minimize the voltage required for a transmitter coupled to a high-speed serial link.

### DETAILED DESCRIPTION OF THE INVENTION

Embodiments of a method, apparatus, and system to manage the power of a high-speed serial link by dynamically modifying the link's voltage to operate at the lowest voltage level that maintains compliance with the allowable serial link error rate are disclosed. In the following description, numerous specific details are set forth. However, it is understood that embodiments may be practiced without these specific details. In other instances, well-known elements, specifications, and protocols have not been discussed in detail in order to avoid obscuring the present invention.

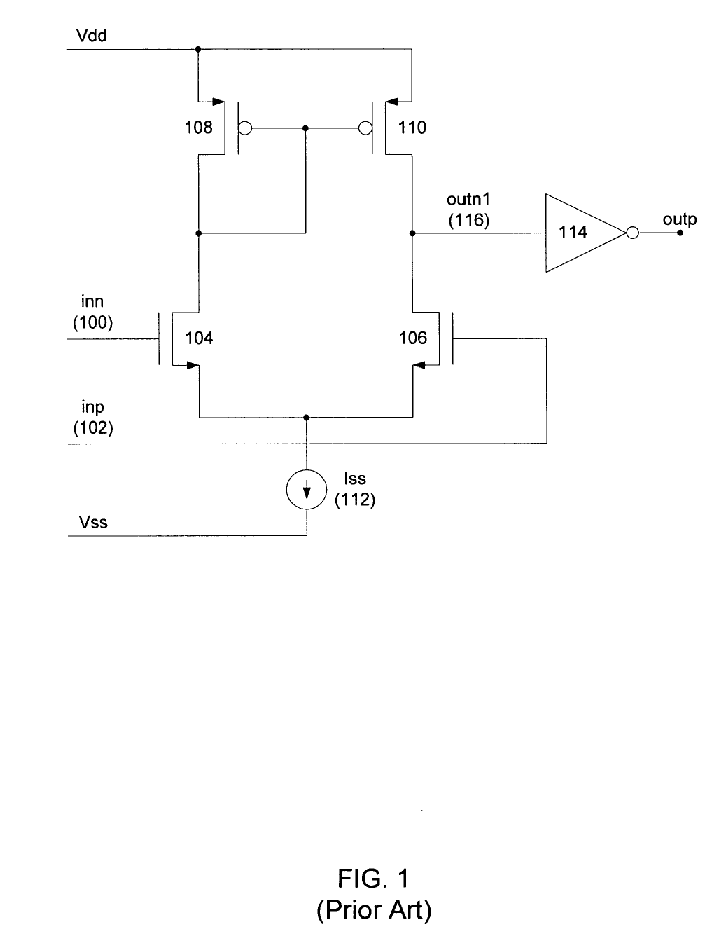

FIG. 1 is a block diagram of a computer system which may be used with embodiments of the present invention. The computer system comprises a processor-memory interconnect 100 for communication between different agents coupled to interconnect 100, such as processors, bridges, memory devices, etc. Processor-memory interconnect 100 includes specific interconnect lines that send arbitration, address, data, and control information (not shown). In one embodiment, central processor 102 is coupled to processor-memory interconnect 100. In another embodiment, there are multiple central processors coupled to processor-memory interconnect (multiple processors are not shown in this figure).

Processor-memory interconnect 100 provides the central processor 102 and other devices access to the system memory 104. A system memory controller controls access to the system memory 104. In one embodiment, the system memory controller is located within the north bridge 108 of a chipset 106 that is coupled to processor-memory interconnect 100. In another embodiment, a system memory controller is located on the same chip as central processor 102 (not shown). Information, instructions, and other data may be stored in system memory 104 for use by central processor 102 as well as many other potential devices.

A graphics subsystem 110 is coupled to the north bridge 108 of the chipset 106. In one embodiment, the graphics subsystem 110 is connected to the north bridge 108 through a PCI-Express™ bi-directional serial interconnect 112. The PCI-Express™ interconnect is a high-speed serial interconnect for transferring information between the graphics subsystem 110 and the rest of the computer system (including the central processor 102 and the system memory 104). The PCI-Express™ interconnect 112 allows direct data transfers between the graphics subsystem and the chipset 106. In this embodiment, the chipset 106 has a PCI-Express™ host controller incorporated within it to couple to the PCI-Express™ interconnect.

The chipset 106 also includes a south bridge that allows access to one or more I/O interconnects. I/O devices, such as I/O device 118 and device 122, are coupled to the south bridge 114 of the chipset 106 through one or more I/O interconnects. In one embodiment, interconnect 124 is a PCI interconnect and I/O device 122 is a network interface card. In one embodiment, interconnect 120 is a high speed Serial Advanced Technology Attachment (SATA) bi-directional interconnect that includes a SATA cable. In this embodiment, I/O device 118 is a SATA device such as a hard disk, a CD drive, or a DVD drive. In this embodiment, a SATA host controller (not shown) is located within the chipset 106. The SATA host controller 112 allows the SATA I/O device 114 to communicate with the rest of the computer system.

In one embodiment, one or more of the high-speed bi-directional serial interconnects in the system in FIG. 1, such as the PCI-Express™ interconnect or the SATA interconnect, includes at least one Error Rate Power Management Controller (ERPMC). The terms “interconnect” and “link” are used interchangeably in the description. The ERPMC can be coupled to the transmission and receiving lines of any device or host controller that utilizes a bi-directional serial interface at each end of the interconnect. For example, in one embodiment, an ERPMC 116 is coupled to the SATA host controller's transmitter and receiver within the chipset 106 in the computer system described in FIG. 1. In this embodiment, the ERPMC 116 is capable of lowering the voltage powering the output drivers within the SATA host controller's transmitter.

As the voltage is lowered to the output drivers, the error rate across the interconnect regarding information sent from the host controller to the SATA I/O device 118 increases. The error rate increases because as the transmitter's supply voltage continues to decline, the transmitter's signal sent across the bus gets weaker. The weaker the signal is, the more likely that SATA packet transmission will result in errors. The SATA specification (SATA Advanced Host Controller Interface 1.0) defines a maximum allowable error rate (e.g. 1 error per 10¹² packets transferred or some similar error rate). If the error rate increases beyond the allowable error rate in the specification, the SATA interconnect falls out of compliance.

Thus, for any SATA transmitter, a minimum voltage level exists to be compliant with the specification. Throughout the industry, most devices' and host controllers' output drivers are supplied with more than enough voltage to be easily compliant with the allowable error rate. Most of these compliant host controllers and devices could have the output drivers still remain compliant with a substantially diminished supply voltage in comparison to the default supply voltage.

Thus, in one embodiment, the ERPMC 116 lowers the voltage supplied to the output drivers to a level just above or equal to the minimum voltage required to remain compliant with the allowable error rate. This ERPMC 116 supply voltage lowering process results in a power reduction to the transmission hardware. Therefore, by adjusting the error rate of the sent data up to the maximum allowable error rate, there is power consumption savings for the SATA host controller and, specifically, the output drivers within the SATA host controller's transmitter.

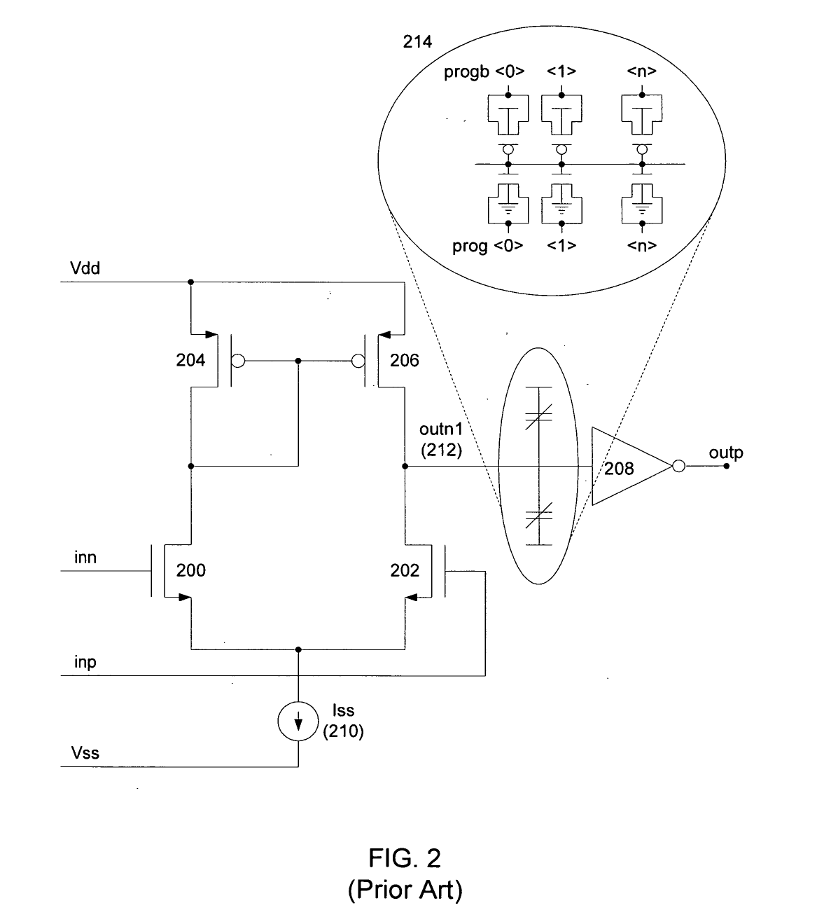

FIG. 2 describes one embodiment of an ERPMC coupled to the transmission and receiving lines of one end of a high-speed bi-directional serial link. The receiver 200 and transmitter 202 are coupled to a full-duplex bi-directional lane in the serial link which totals two differential signal pairs. This includes four transmission lines 204. Furthermore, data is sent across data line 206 to be transmitted by the transmitter 202 across the serial link and data is received from data line 208 that was received by the receiver 200 from the serial link.

In one embodiment, the link is initialized to begin operation. At this point, the ERPMC 210 sets the voltage level at the voltage control circuit 212 to a standard nominal voltage that is compliant with the specification. The voltage control 212 feeds voltage to the transmitter 202 from a voltage source (Vcc) and can increase or decrease voltage supplied to the transmitter 202. At this point a low voltage calibration routine begins. In one embodiment, the ERPMC 210 and the transmitter 202 calibrate the voltage during normal transmission operation. In another embodiment, the ERPMC 210 and the transmitter 202 calibrate the voltage by sending special test packets across the serial link to the receiver.

In this embodiment, a series of packets will be sent specifically to determine whether any errors occur due to the transmission. The device on the other end of the serial link (not shown in FIG. 2) receives the packets and returns acknowledgement packets that can be comprised of control packets or any other form of data packet that returns the status of the transmission. These acknowledgement packets are returned by the device on the other end of the serial link by transmitting across the link to the receiver 200. The receiver 200 receives the packets from the link in the form of a differential signal and converts the differential signal to a single-ended signal onto data line 208, which is coupled to the ERPMC 210. The ERPMC 210 receives the returned acknowledgement packets and determines the error rate of the packets sent by comparing the total number of packets sent versus the total number of errors during the transmission of the packets, which is established from the returned acknowledgement packets. If the error rate is below the maximum allowable error rate in the specification, the ERPMC 210 steps down the voltage and the entire process repeats. In one embodiment, the change in voltage level per “step down” is the lowest delta in voltage that could significantly alter the error rate. The voltage changes should be small enough so that the ERPMC 210 can have a fine granularity for error rate changes to allow for the allowable error rate to be closely approached. Though, the voltage changes should be large enough to minimize any unnecessary overhead of excessive iterations of the process above.

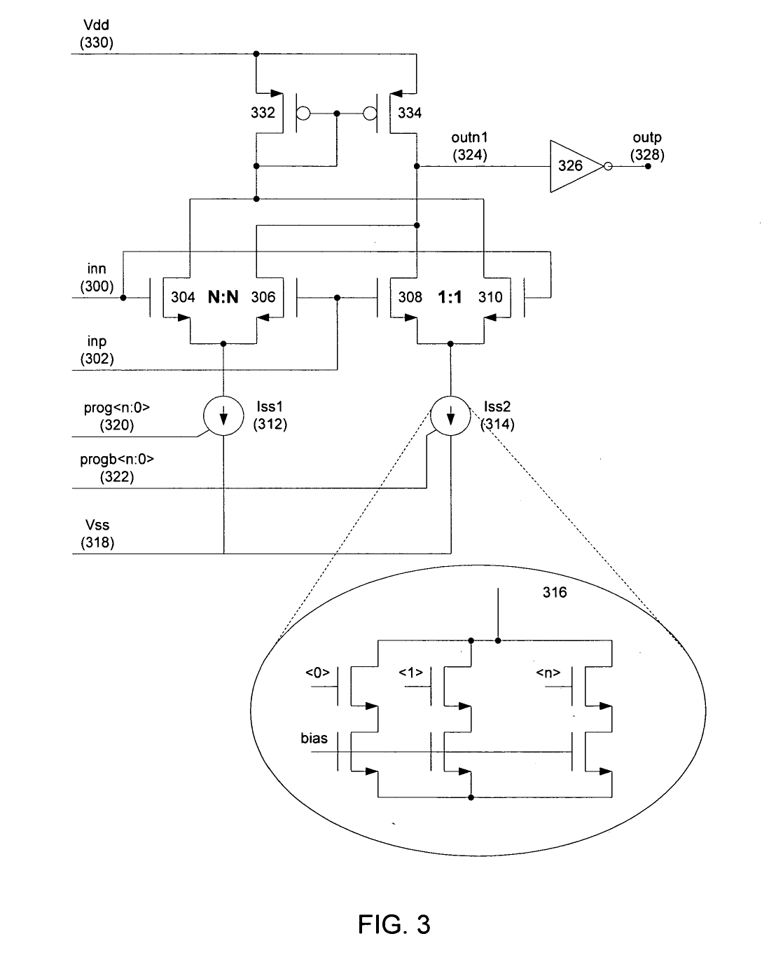

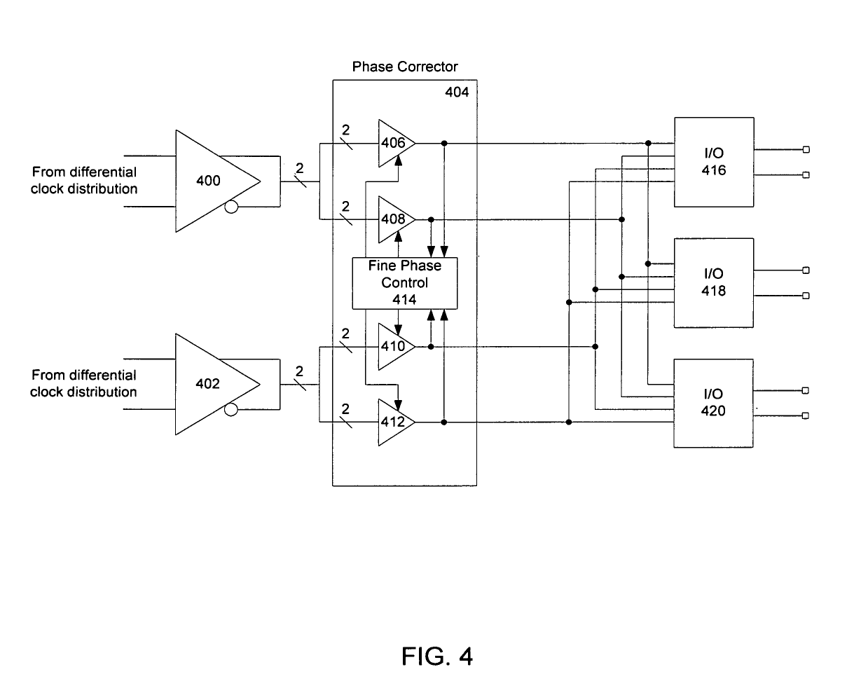

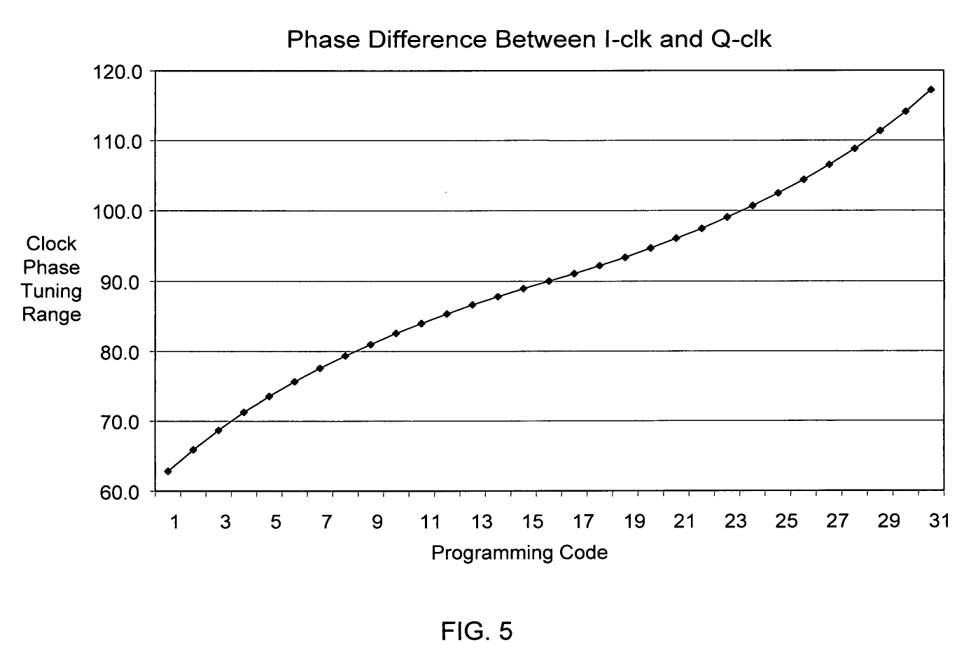

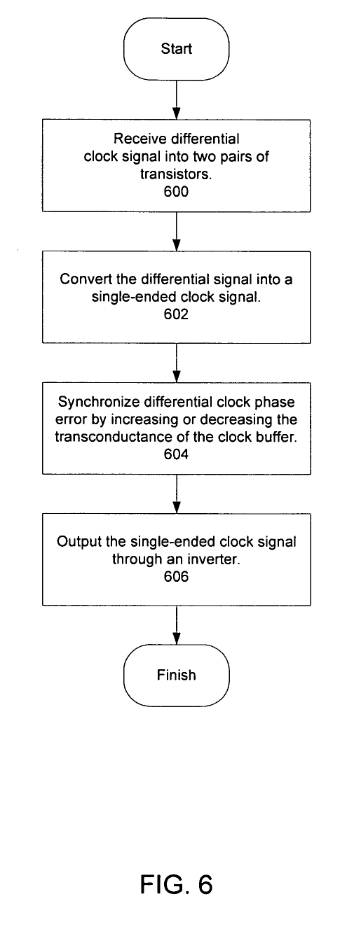

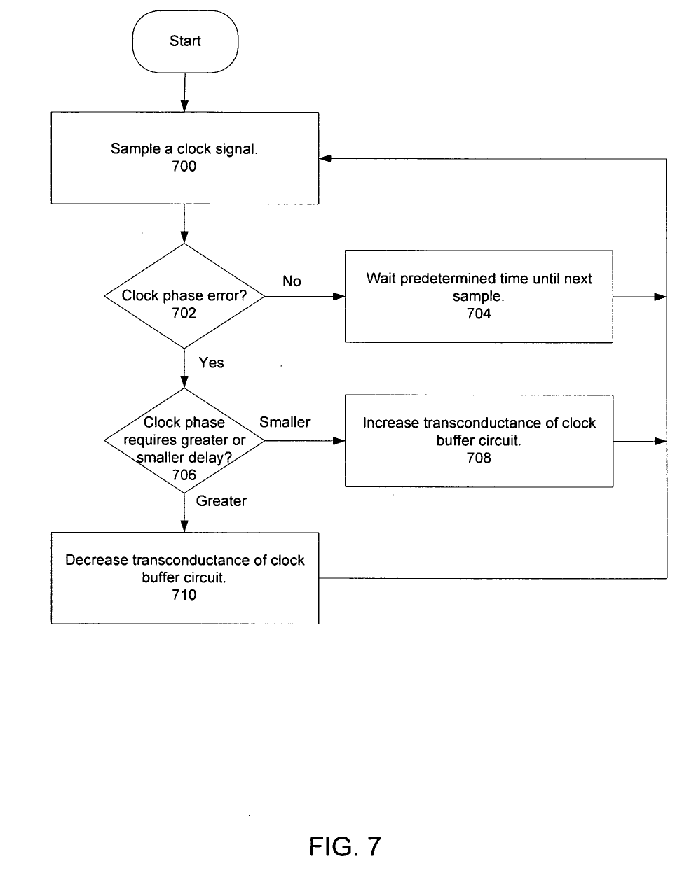

FIG. 3 is a flow diagram of one embodiment of a process to minimize the voltage required for a transmitter coupled to a high-speed serial link. The process is performed by processing logic that may comprise hardware (circuitry, dedicated logic, etc.), software (such as is run on a general purpose computer system or a dedicated machine), or a combination of both. Referring to FIG. 3, the process begins by processing logic initializing the link to allow transmission of data to begin (processing block 300). In one embodiment, the link is a PCI-Express™ link. In another embodiment, the link is a SATA interconnect. In other embodiments, the link may be any other type of high-speed bi-directional serial link.

Next, processing logic sets the error rate threshold (processing block 302). The error rate threshold is the maximum error rate allowable over the link by the link's specification. This threshold will change based on the type of link involved. Then, processing logic starts the voltage calibration routine on the link (processing block 304). In one embodiment, the calibration routine may be part of the normal operation of the link, thus calibration takes place in unison with data transfers. In another embodiment, the routine may be a special calibration routine that does not coexist with data transfers over the link. In this embodiment, the calibration routine initially will run as part of the computer system's boot up procedures, though, after the initial routine is run, subsequent recalibration routines would temporarily suspend normal link data transfer operations while voltage is recalibrated.

In one embodiment, the voltage calibration routine begins with the transmitter with modifiable voltage (transmitter 202 in FIG. 2) sending a series of test data packets across the link to the device at the other end. The device at the other end receives each packet and sends acknowledgements back per packet over the link which state whether there were any errors contained within the packets. The receiver (receiver 200 in FIG. 2) receives the acknowledgement packets from the other device, which allows the ERPMC (210 in FIG. 2) to determine the error rate of the sent packets. Thus, processing logic determines whether the error rate threshold has been exceeded (processing block 306).

If the error rate threshold has not been exceeded, then processing logic steps down the voltage sent to the transmitter's output drivers (processing block 308) and then the process returns to block 306 where processing logic again determines whether the error rate threshold has been exceeded. If the error rate threshold has been exceeded, it indicates that the voltage level is too low and, thus, creating too many transmission errors. In this case, processing logic steps up the voltage sent to the transmitter's output drivers (processing logic 310).

Then, again, processing logic determines whether the error rate threshold has been exceeded (processing block 306). If the error rate threshold is still exceeded, then the process returns to block 310 to step up the voltage again. Otherwise, if the error rate threshold is no longer exceeded, then processing logic waits for a recalibration interval period of time (processing block 314) and then the process returns to block 304 for another voltage calibration. In one embodiment, the recalibration interval is set in the BIOS at system start up. In another embodiment, the operating system running on the computer system that the link is located within has the capability to modify the recalibration interval. In this embodiment, the recalibration interval is modified by the operating system based on the environment where the computer system is located.

Environmental determination may be made by any number of different methodologies. For example, if the computer system is a mobile computer, the recalibration interval can be shortened when the system is plugged in because there may be more electrical noise and interference changes in an office environment than a non-office environment. In another example, the computer system may have a motion detector, which can determine whether the computer itself is in motion. If the computer is in motion the recalibration interval will shorten since the change in electrical interference may become more pronounced than in a stationary environment.

In another embodiment, there is no recalibration interval. In this embodiment, the voltage calibration begins immediately after the voltage level was set in the previous calibration routine. This embodiment works in conjunction with a calibration routine that runs during normal link operations.

Thus, embodiments of a method, apparatus, and system to enable native SATA device presence detection and hot-plugging in SATA AHCI low power mode are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
dynamically adjusting the output voltage of output drivers of one side of a bi-directional serial link down to a lowest voltage level that is able to maintain compliance with an error rate allowance threshold of the serial link; and
operating the one side of the serial link at the voltage level.

2. The method of claim 1, wherein dynamically adjusting the output voltage further comprises:
sending one or more calibration data packets across the serial link;
receiving from the serial link the number of errors found within the sent one or more calibration data packets;
calculating the error rate based on the number of errors found over the entire number of packets sent; and
stepping down the output voltage if the error rate is lower than the highest allowable error rate threshold.

3. The method of claim 2, further comprising:
continuously stepping down the output voltage until the error rate exceeds the error rate allowance threshold; and
once the error rate allowance threshold has been crossed, stepping up the output voltage to the lowest voltage level that maintains compliance with the error rate allowance.

4. The method of claim 3, wherein stepping up or down voltage further comprises increasing or decreasing the voltage level by a set predetermined amount.

5. The method of claim 1, further comprising:
once the lowest voltage level that is able to maintain compliance is found, operating the one side of the serial link at that voltage level for a recalibration interval amount of time;
after the recalibration interval amount of time, dynamically readjusting the output voltage of the output drivers of the one side of the bi-directional serial link down to the lowest voltage level that is able to maintain compliance with the error rate allowance threshold of the serial link; and
operating the one side of the serial link at the readjusted voltage level.

6. The method of claim 5, wherein the recalibration interval amount of time is determined by an operating system located on a computer system that the bi-directional serial link is a part of.

7. The method of claim 6, wherein the operating system dynamically modifies the recalibration interval amount of time based on the environment the computer system is located within.

8. An apparatus, comprising:
a serial link error rate power management controller to
dynamically adjust the output voltage of output drivers of one side of a bi-directional serial link down to a lowest voltage level that is able to maintain compliance with an error rate allowance threshold of the serial link; and
operate the one side of the serial link at the voltage level.

9. The apparatus of claim 8, wherein the serial link error rate power management controller is further operable to:
send one or more calibration data packets across the serial link;
receive from the serial link the number of errors found within the sent one or more calibration data packets;
calculate the error rate based on the number of errors found over the entire number of packets sent; and
step down the output voltage if the error rate is lower than the highest allowable error rate threshold.

10. The apparatus of claim 9, wherein the serial link error rate power management controller is further operable to:
continuously step down the output voltage until the error rate exceeds the error rate allowance threshold; and
once the error rate allowance threshold has been crossed, step up the output voltage to the lowest voltage level that maintains compliance with the error rate allowance.

11. The apparatus of claim 10, wherein to step up or down voltage further comprises to increase or decrease the voltage level by a set predetermined amount.

12. The apparatus of claim 8, wherein the serial link error rate power management controller is further operable to:
once the lowest voltage level that is able to maintain compliance is found, operate the one side of the serial link at that voltage level for a recalibration interval amount of time;
after the recalibration interval amount of time, dynamically readjust the output voltage of the output drivers of the one side of the bi-directional serial link down to the lowest voltage level that is able to maintain compliance with the error rate allowance threshold of the serial link; and
operate the one side of the serial link at the readjusted voltage level.

13. A system, comprising:
a first interconnect;
a processor coupled to the first interconnect;
a memory coupled to the first interconnect;
a network interface card coupled to the first interconnect;
a second interconnect, comprising a bi-directional serial link;
a chipset coupled to the first and second interconnects; and
a serial link error rate power management controller, coupled to the second interconnect to
dynamically adjust the output voltage of output drivers of one side of the bi-directional serial link down to a lowest voltage level that is able to maintain compliance with an error rate allowance threshold of the serial link; and
operate the one side of the serial link at the voltage level.

14. The system of claim 13, wherein the serial link error rate power management controller is further operable to:
send one or more calibration data packets across the serial link;
receive from the serial link the number of errors found within the sent one or more calibration data packets;
calculate the error rate based on the number of errors found over the entire number of packets sent; and
step down the output voltage if the error rate is lower than the highest allowable error rate threshold.

15. The system of claim 14, wherein the serial link error rate power management controller is further operable to:
continuously step down the output voltage until the error rate exceeds the error rate allowance threshold; and
once the error rate allowance threshold has been crossed, step up the output voltage to the lowest voltage level that maintains compliance with the error rate allowance.

16. The system of claim 13, wherein the serial link power management controller is further operable to:
once the lowest voltage level that is able to maintain compliance is found, operate the one side of the serial link at that voltage level for a recalibration interval amount of time;
after the recalibration interval amount of time, dynamically readjust the output voltage of the output drivers of the one side of the bi-directional serial link down to the lowest voltage level that is able to maintain compliance with the error rate allowance threshold of the serial link; and
operate the one side of the serial link at the readjusted voltage level.

17. The system of claim 16, wherein the recalibration interval amount of time is determined by an operating system stored in the memory located in the system.

18. The system of claim 17, wherein the operating system dynamically modifies the recalibration interval amount of time based on the environment the system is located within.

19. The system of claim 13, wherein the system has one or more additional processors coupled to the first interconnect.
